(19) United States
(12) Patent Application Publication
(10) Pub. No.: US 2014/0082252 A1
(43) Pub. Date: Mar. 20, 2014

(54) Combined Two-Level Cache Directory

(71) Applicants: Khary J. Alexander, Poughkeepsie, NY (US); Jonathan T. Hsieh, Poughkeepsie, NY (US); Christian Jacobi, Schoenaich (DE); Barry W. Krumm, Poughkeepsie, NY (US)

(72) Inventors: Khary J. Alexander, Poughkeepsie, NY (US); Jonathan T. Hsieh, Poughkeepsie, NY (US); Christian Jacobi, Schoenaich (DE); Barry W. Krumm, Poughkeepsie, NY (US)

(73) Assignee: International Business Machines Corporation, Armonk, NY (US)

(21) Appl. No.: 13/621,465

(22) Filed: Sep. 17, 2012

(51) Int. Cl. G06F 12/08; G06F 12/10

(52) U.S. Cl. 711/3; 711/E12.061; 711/E12.024

(57) ABSTRACT

Responsive to receiving a logical address for a cache access, a mechanism looks up a first portion of the logical address in a local cache directory for a local cache. The local cache directory returns a set identifier for each set in the local cache directory. Each set identifier indicates a set within a higher level cache directory. The mechanism looks up a second portion of the logical address in the higher level cache directory and compares each absolute address value received from the higher level cache directory to an absolute address received from a translation look-aside buffer to generate a higher level cache hit signal. The mechanism compares the higher level cache hit signal to each set identifier to generate a local cache hit signal and responsive to the local cache hit signal indicating a local cache hit, accesses the local cache based on the local cache hit signal.

### BACKGROUND

The present application relates generally to an improved data processing apparatus and method and more specifically to mechanisms for combined two-level cache directory.

In traditional cache designs, the L2 cache directory is accessed after the L1 cache directory has determined that an L1 miss has occurred. This leads to the added latency for L1 misses.

A classical virtually-indexed directory contains the following fields: valid bit, exclusive bit, key, and absolute address. The valid bit indicates the entry is valid. The exclusive bit indicates the line is owned exclusively. The key is a storage key for protection or may comprise other information. The absolute address comprises the absolute address tag.

In order to determine a cache hit for a logical address/absolute address access, the cache controller accesses the directory into the row determined by the logical address and then compares the absolute address of all set identifiers of the directory to determine whether there is a cache hit. The L1 and L2 hit signals are used to select the correct data from the data cache arrays. This is typically the path determining the latency.

### SUMMARY

In one illustrative embodiment, a method is provided for accessing a cache. The method comprises responsive to receiving a logical address for a cache access, looking up a first portion of the logical address in a local cache directory for a local cache. The local cache directory returns a set identifier for each set in the local cache directory. Each set identifier indicates a set within a higher level cache directory. The method further comprises looking up the logical address in a translation look-aside buffer. The translation look-aside buffer returns an absolute address. The method further comprises looking up a second portion of the logical address in the higher level cache directory. The higher level cache directory returns an absolute address value for each set in the higher level cache directory. The method further comprises comparing each absolute address value received from the higher level cache directory to the absolute address received from the translation look-aside buffer to generate a higher level cache hit signal. The method further comprises comparing the higher level cache hit signal to each set identifier to generate a local cache hit signal. The method further comprises responsive to the local cache hit signal indicating a local cache hit, accessing the local cache based on the local cache hit signal.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a block diagram of an example data processing system in which aspects of the illustrative embodiments may be implemented;

FIG. 2 is a block diagram illustrating a one level cache structure;

FIG. 3 is a block diagram illustrating a two-level cache structure in which aspects of the illustrative embodiments may be implemented;

FIGS. 4A and 4B are diagrams illustrating a cache directory and data cache access in which aspects of the illustrative embodiments may be implemented;

FIG. 5 is a diagram illustrating a two-level cache directory in accordance with an illustrative embodiment;

FIG. 6 is a block diagram illustrating a cache structure with two-level cache directory in accordance with art illustrative embodiment;

FIG. 7 is a block diagram illustrating a cache structure with two-level cache directory in accordance with an illustrative embodiment;

FIG. 8 is a flowchart illustrating operation of a cache with a two-level directory in accordance with an illustrative embodiment; and

FIGS. 9A and 9B are flowcharts illustrating operation of a cache identifying cache victims for overwriting in accordance with an illustrative embodiment.

### DETAILED DESCRIPTION

The illustrative embodiments provide a mechanism for implementing a cache directory structure that combines the L1 and L2 directories. A directory access always determines L1 and L2 hit simultaneously, effectively reducing the latency of L1 misses.

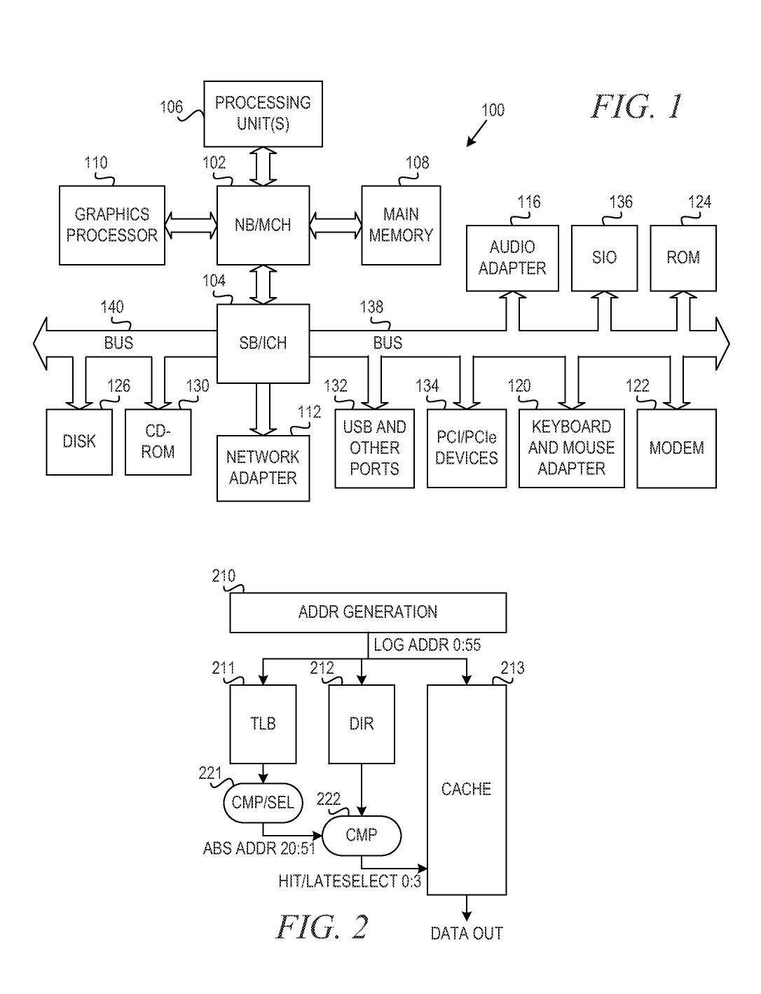

The illustrative embodiments may be utilized in many different types of data processing environments. In order to provide a context for the description of the specific elements and functionality of the illustrative embodiments, FIG. 1 is provided hereafter as an example environment in which aspects of the illustrative embodiments may be implemented. It should be appreciated that FIG. 1 is only an example and is not intended to assert or imply any limitation with regard to the environments in which aspects or embodiments of the present invention may be implemented. Many modifications to the depicted environments may be made without departing from the spirit and scope of the present invention.

FIG. 1 is a block diagram of an example data processing system in which aspects of the illustrative embodiments may be implemented. Data processing system 100 is an example of a computer in which computer usable code or instructions implementing the processes for illustrative embodiments of the present invention may be located.

In the depicted example, data processing system 100 employs a hub architecture including north bridge and memory controller hub (NB/MCH) 102 and south bridge and input/output (I/O) controller hub (SB/ICH) 104. Processing unit 106, main memory 108, and graphics processor 110 are connected to NB/MCH 102. Graphics processor 110 may be connected to NB/MCI-R 102 through an accelerated graphics port (AGP).

In the depicted example, local area network (LAN) adapter 112 connects to SB/ICH 104. Audio adapter 116, keyboard and mouse adapter 120, modem 122, read only memory (ROM) 124, hard disk drive (HDD) 126, CD-ROM drive 130, universal serial bus (USB) ports and other communication ports 132, and PCI/PCIe devices 134 connect to SB/ICH 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash basic input/output system (BIOS).

HDD 126 and CD-ROM drive 130 connect to SB/ICH 104 through bus 140. HDD 126 and CD-ROM drive 130 may use, for example, an integrated drive electronics (IDE) or serial advanced technology attachment (SATA) interface. Super I/O (SIO) device 136 may be connected to SB/ICH 104.

An operating system runs on processing unit 106. The operating system coordinates and provides control of various components within the data processing system 100 in FIG. 1. As a client, the operating system may be a commercially available operating system such as Microsoft Windows 7 (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 100 (Java is a trademark of Oracle and/or its affiliates).

As a server, data processing system 100 may be, for example, an IBM® eServer™ System p® computer system, running the Advanced Interactive Executive (AIX®) operating system or the LINUX operating system (IBM, eServer, System p, and AIX are trademarks of International Business Machines Corporation in the United States, other countries, or both, and LINUX is a registered trademark of Linus Torvalds in the United States, other countries, or both). Data processing system 100 may be a symmetric multiprocessor (SMP) system including a plurality of processors in processing unit 106. Alternatively, a single processor system may be employed.

Instructions for the operating system, the object-oriented programming system, and applications or programs are located on storage devices, such as HDD 126, and may be loaded into main memory 108 for execution by processing unit 106. The processes for illustrative embodiments of the present invention may be performed by processing unit 106 using computer usable program code, which may be located in a memory such as, for example, main memory 108, ROM 124, or in one or more peripheral devices 126 and 130, for example.

A bus system, such as bus 138 or bus 140 as shown in FIG. 1, may be comprised of one or more buses. Of course, the bus system may be implemented using any type of communication fabric or architecture that provides for a transfer of data between different components or devices attached to the fabric or architecture. A communication unit, such as modem 122 or network adapter 112 of FIG. 1, may include one or more devices used to transmit and receive data. A memory may be, for example, main memory 108, ROM 124, or a cache such as found in NB/MCH 102 in FIG. 1.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system, other than the SMP system mentioned previously, without departing from the spirit and scope of the present invention.

Moreover, the data processing system 100 may take the form of any of a number of different data processing systems including client computing devices, server computing devices, a tablet computer, laptop computer, telephone or other communication device, a personal digital assistant (PDA), or the like. In some illustrative examples, data processing system 100 may be a portable computing device that is configured with flash memory to provide non-volatile memory for storing operating system files and/or user-generated data, for example. Essentially, data processing system 100 may be any known or later developed data processing system without architectural limitation.

FIG. 2 is a block diagram illustrating a one level cache structure. The cache structure includes an address generation component 210 that generates a logical address being accessed. In the depicted example, the logical address has 55 bits (0:55). The address generation component 210 provides the logical address to the translation look-aside buffer (TLB) 211, the cache directory 212, and the data cache 213. If there is a hit in the cache directory 212, the cache structure accesses the data cache 213 using the logical address.

TLB 211 uses the logical address as a search key and provides an absolute address. If the requested address is present in the TLB 211, the search yields a match quickly and the retrieved absolute address can be used to access memory. Compare/select component 221 provides the absolute address responsive to a TLB hit.

The cache directory 212 outputs a valid bit, an exclusivity bit, a key, and an absolute address based on the received logical address. Compare component 222 compares the absolute address received from TLB 211, via component 221, to the absolute address provided by the cache directory 212. Compare component 222 generates a hit signal to the data cache 213, which generates data output based on the logical address from the address generation component 210 and the hit signal from the compare component 222.

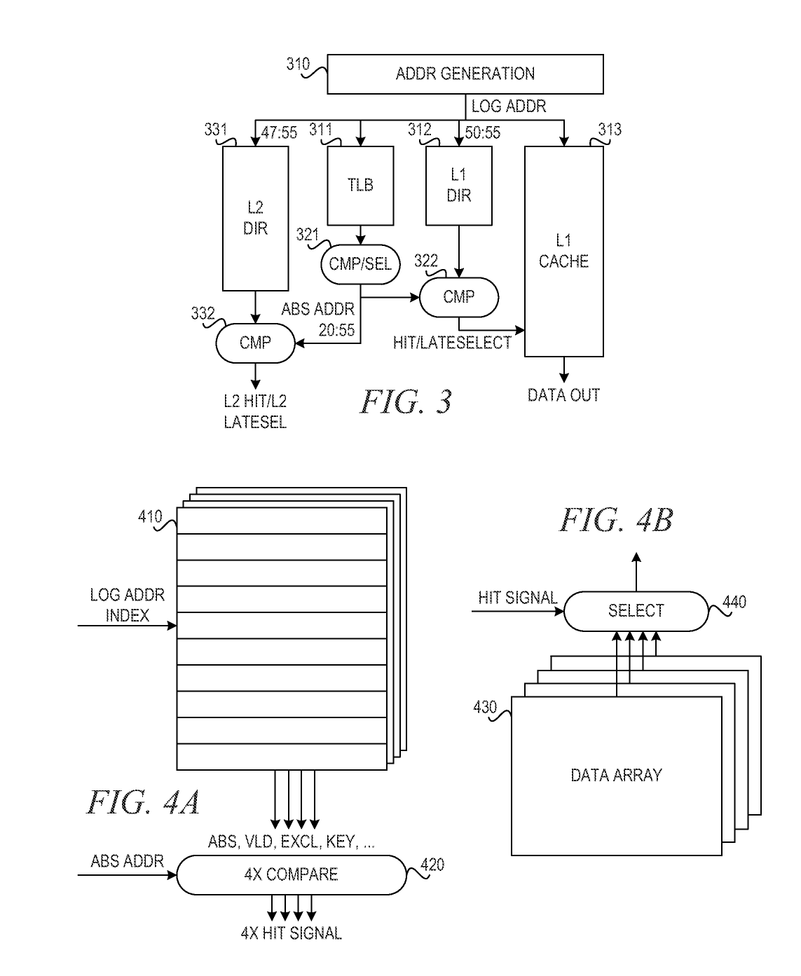

FIG. 3 is a block diagram illustrating a two-level cache structure in which aspects of the illustrative embodiments may be implemented. The cache structure includes an address generation component 310 that generates a logical address being accessed. In the depicted example, the logical address has 55 bits (0:55). The address generation component 310 provides the logical address to the translation look-aside buffer (TLB) 311, the level one (L1) cache directory 312, the L1 data cache 313, and the L2 cache directory 331. In the depicted example, the address generation component 310 provides bits 47:55 of the logical address to L2 directory 331 and provides bits 50:55 of the logical address to L1 directory 312.

TLB 311 uses the logical address as a search key and provides an absolute address. If the requested address is present in the TLB 311, the search yields a match quickly and the retrieved absolute address can be used to access memory. Compare/select component 321 provides the absolute address responsive to a TLB hit.

The L1 cache directory 312 outputs a valid bit, an exclusivity bit, a key, and an absolute address based on the received logical address. Compare component 322 compares the absolute address received from TLB 311, via component 321, to the absolute address provided by the cache directory 312. Compare component. 322 generates a hit signal to the L1 data cache 313, which generates data output based on the logical address from the address generation component 310 and the hit signal from the compare component 322.

The L2 cache directory 331 outputs a valid bit, an exclusivity bit, a key, and an absolute address based on the received logical address. Compare component 332 compares the absolute address received from TLB 311, via component 321, to the absolute address provided by the cache directory 331. Compare component 332 generates an L2 hit signal.

FIGS. 4A and 4B are diagrams illustrating a cache directory and data cache access in which aspects of the illustrative embodiments may be implemented. With reference to FIG. 4A, in the depicted example, cache directory 410 includes four pages of directory entries, each of which stores an absolute address, valid bit, exclusive bit, and key. For a given received logical address, cache directory 410 provides four absolute addresses, one from each page. Compare component 420 compares the four absolute addresses from cache directory 410 to the absolute address from the TLB (not shown). Compare component 420 provides a 4-bit hit signal.

Turning to FIG. 4B, the data cache comprises a four page data array 430. The data array 430 provides four data outputs based on the logical address. Select component 440 selects zero or one data output based on the hit signal from compare component 420.

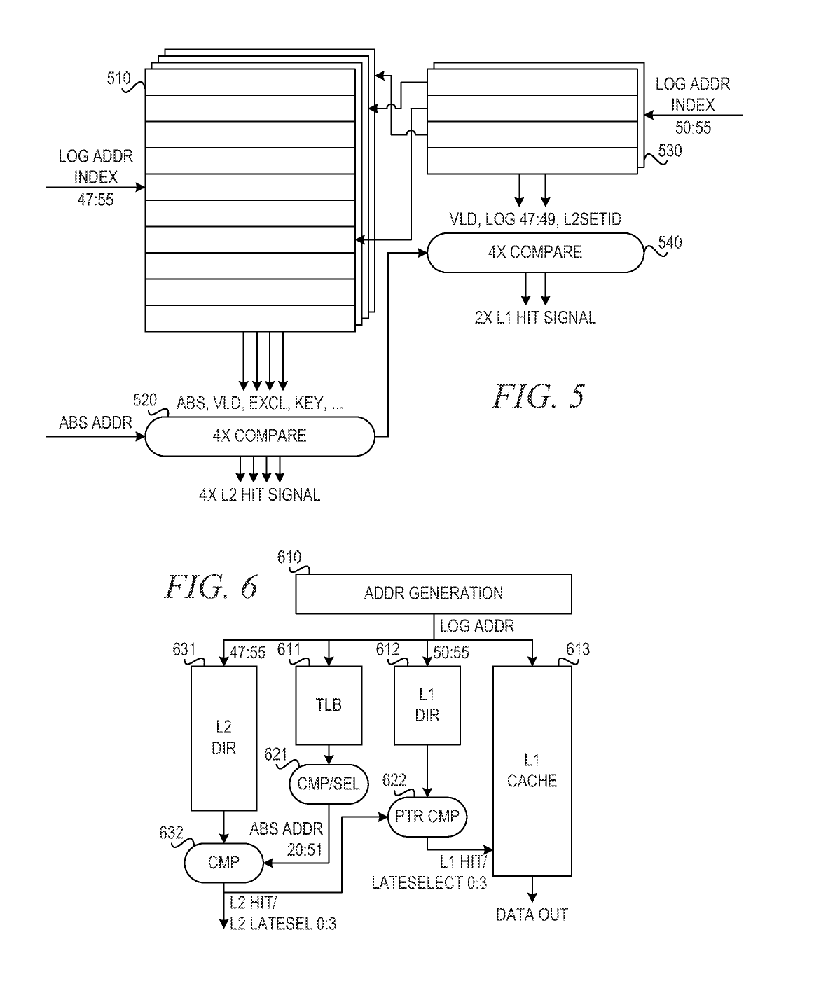

FIG. 5 is a diagram illustrating a two-level cache directory in accordance with an illustrative embodiment. In the depicted example, L2 cache directory 510 includes four pages of directory entries, each of which stores an absolute address, valid bit, exclusive bit, and key. For a given received logical address, cache directory 510 provides four absolute addresses, one from each page. Compare component 520 compares the four absolute addresses from cache directory 510 to the absolute address from the TLB (not shown). Compare component 520 provides a 4-bit hit signal to the L2 data arrays.

In the depicted example, L1 cache directory 530 includes two pages of directory entries, each of which stores a valid bit, logical address (bits 47:49), and L2 set ID. For each entry in L1 cache directory 530, the L2 set ID points to an entry in L2 cache directory 510. Compare component 540 compares the 4-bit L2 hit signal received from compare component 520 to the L2 set ID provided by the L1 directory 530 to generate a 2-bit L1 hit signal. The cache then uses the L2 set ID and logical address bits to access the L2 cache directory to obtain exclusive bit and key information, for example.

The L2 directory contains the following fields: valid bit, exclusive bit, key, and absolute address. The valid bit indicates the entry is valid. The exclusive bit indicates the cache line is owned exclusively. The key is a storage key for protection, and may include any other set of miscellaneous information. The L1 directory contains the following fields: valid bit, logical address 47:49, and L2 set ID. The valid bit indicates the L1 directory entry is valid. The logical address 47:49 is an extension of the L1 logical address to allow access of the L2 directory. The L2 set ID identifies which L2 directory set contains the L1 cache entry.

In effect, the L1 directory no longer contains actual directory content, but a pointer to an L2 directory entry. The cache only saves the L2 set ID and logical address 47:49, because the remaining “coordinate” in the L2 directory (namely logical address 50:55) is the same as what is used to access the L1 directory.

The L2 hit is computed the same way as in the prior art. There is an L1 hit if the entry for the L2 set ID is valid, the accessed logical address matches the entry's logical address, and the L2 set indicated by the L1 directory entry's set ID has a hit. The L1 directory does not save the exclusive bit or key (or other miscellaneous information), because that information is directly taken from the L2 directory entry to which the L1 entry points.

FIG. 6 is a block diagram illustrating a cache structure with two-level cache directory in accordance with an illustrative embodiment. The cache structure includes an address generation component 610 that generates a logical address being accessed. The address generation component 610 provides the logical address to the translation look-aside buffer (TLB) 611, the level one (L1) cache directory 612, the L1 data cache 613, and the L2 cache directory 631. In the depicted example, the address generation component 610 provides bits 47:55 of the logical address to L2 directory 631 and provides bits 50:55 of the logical address to L1 directory 612.

TLB 611 uses the logical address as a search key and provides an absolute address. If the requested address is present in the TLB 611, the search yields a match quickly and the retrieved absolute address can be used to access memory. Compare/select component 621 provides the absolute address responsive to a TLB hit.

The L2 cache directory 631 outputs a valid bit, an exclusivity bit, a key, and an absolute address based on the received logical address. Compare component 632 compares the absolute address received from TLB 611, via component 621, to the absolute address provided by L2 cache directory 631. Compare component 632 generates a hit signal to the L2 data cache (not shown), which generates data output based on the logical address from the address generation component 610 and the hit signal from the compare component 632.

The L1 cache directory 631 outputs a L2 set ID based on the received logical address. Compare component 622 compares the L2 hit signal received form compare component 632 to the L2 set ID provided by L1 cache directory 612. Compare component 622 generates an L1 hit signal to L1 data cache 613.

During all accesses, the two directory structures are accessed in parallel. During directory invalidations, both the L1 and L2 valid bits are turned off simultaneously.

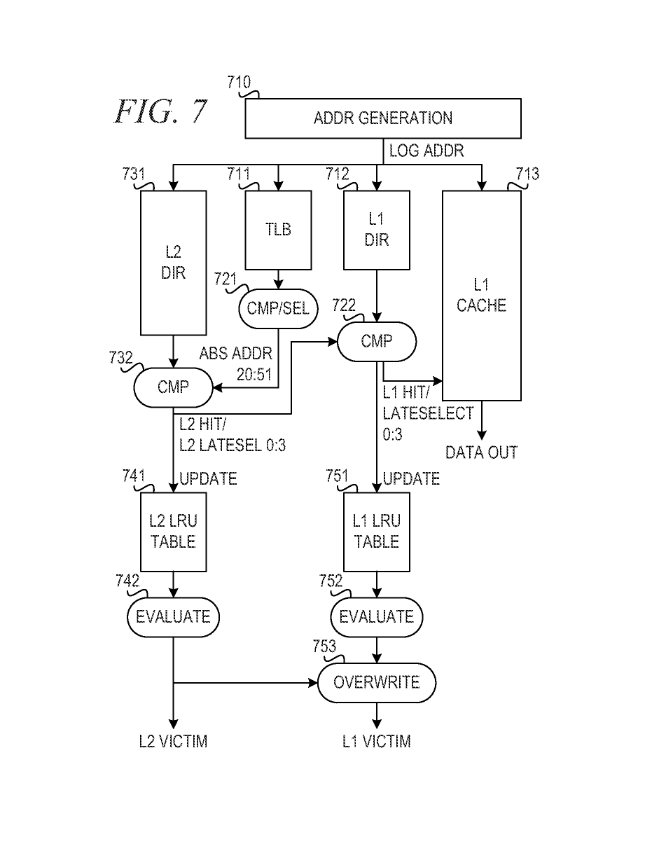

FIG. 7 is a block diagram illustrating a cache structure with two-level cache directory in accordance with an illustrative embodiment. The cache structure includes an address generation component 710 that generates a logical address being accessed. The address generation component 710 provides the logical address to the translation look-aside buffer (TLB) 711, the level one (L1) cache directory 712, the L1 data cache 713, and the L2 cache directory 731. In the depicted example, the address generation component 710 provides the logical address to L2 directory 731 and provides the logical address to L1 directory 712.

TLB 711 uses the logical address as a search key and provides an absolute address. If the requested address is present in the TLB 711, the search yields a match quickly and the retrieved absolute address can be used to access memory. Compare/select component 721 provides the absolute address responsive to a TLB hit.

The L2 cache directory 731 outputs a valid bit, an exclusivity bit, a key, and an absolute address based on the received logical address. Compare component 732 compares the absolute address received from TLB 711, via component 721, to the absolute address provided by L2 cache directory 731. Compare component 732 generates a hit signal to the L2 data cache (not shown), which generates data output based on the logical address from the address generation component 710 and the hit signal from the compare component 732.

The L1 cache directory 731 outputs a L2 set ID based on the received logical address. Compare component 722 compares the L2 hit signal received form compare component 732 to the L2 set ID provided by L1 cache directory 712. Compare component 722 generates an L1 hit signal to L1 data cache 713.

L2 least recently used (LRU) table 741 identifies the entries in L2 directory 731 that have been least recently used and may be candidates to be overwritten in the L2 cache. Evaluate component 742 receives an LRU victim from L2 LRU table 741 and provides the L2 victim to be invalidated. L1 LRU table 751 identifies the entries in L2 directory 712 that have been least recently used and may be candidates to be overwritten in the L2 cache 713.

When a least recently used (LRU) victim is to be selected for the L2 cache and there is a valid L1 entry pointing to the L2 LRU victim, the L1 LRU is forced to that valid L1 entry. That prevents the possibility of leaving the L1 pointer stranded.

Evaluate component receives an LRU victim from L2 LRU table 741 and presents the L2 victim to be overwritten in the L2 cache.

Evaluate component 752 receives an LRU victim from L1 LRU table 751 and provides the L1 victim to be invalidated. If an L1 entry in L1 directory 712 points to the L2 victim, overwrite component 753 selects that L1 entry as the L1 victim to be overwritten in the L1 cache.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

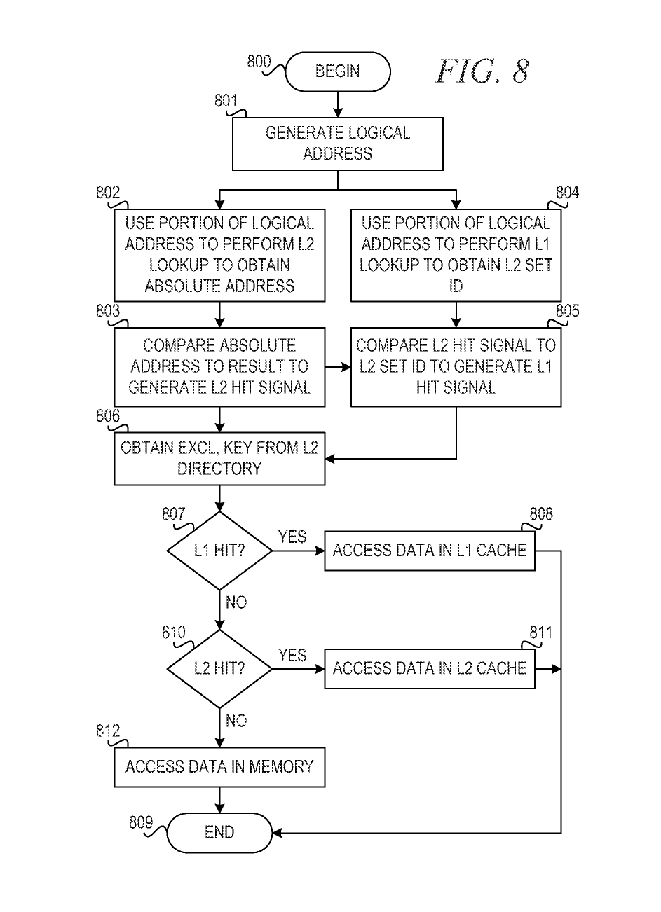

FIG. 8 is a flowchart illustrating operation of a cache with a two-level directory in accordance with an illustrative embodiment. Operation begins (block 800), and the cache generates a logical address (block 801). The cache uses a portion of the logical address to perform L2 lookup to obtain an absolute address (block 802). The cache compares the absolute address to the result of the L2 lookup to generate an L2 hit signal (block 803).

In parallel to the L2 lookup, the cache uses a portion of the logical address to perform an L1 lookup to obtain an L2 set ID (block 804). The cache compares the L2 set ID to the L2 hit signal from block 803 to generate an L1 hit signal (block 805).

Thereafter, the cache obtains the exclusive bit and key from the L2 directory (block 806). The cache determines whether there is an L1 hit (block 807). If there is an L1 hit, the cache accesses the data in the L1 cache (block 808), and operation ends (block 809).

If there is not an L1 hit in block 807, the cache determines whether there is an L2 hit (block 810). If there is an L2 hit, the cache accesses the data in the L2 cache (block 811), and operation ends (block 809).

If there is not an L2 hit in block 810, the cache accesses the data in memory (block 812), and operation ends (block 809).

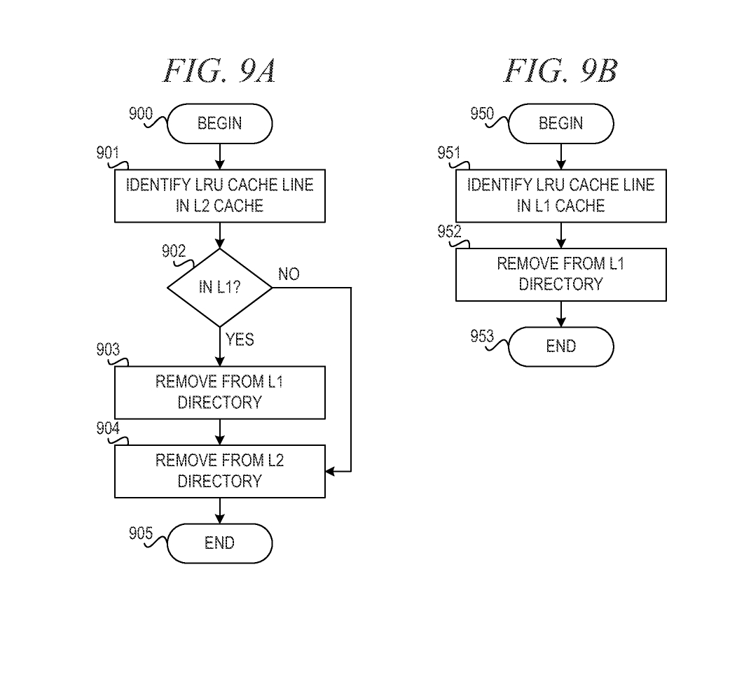

FIGS. 9A and 9B are flowcharts illustrating operation of a cache identifying cache victims for overwriting in accordance with an illustrative embodiment. With reference to FIG. 9A, operation begins when a victim cache line is needed for the L2 cache (block 900). The cache identifies a least recently used (LRU) cache line in the L2 cache (block 901). The cache determines whether there is an entry in the L1 directory pointing to the identified L2 entry (block 902). If there is an entry in the L1 directory pointing to the identified L2 entry, the cache removes (invalidates) the entry in the L1 directory (block 903). Then, the cache removes the entry in the L2 directory (block 904), and operation ends (block 905).

If there is not an entry in the L1 directory pointing to the identified L2 entry in block 902, the cache removes (invalidates) the entry in the L2 directory (block 904). Thereafter, operation ends (block 905).

Turning now to FIG. 9B, operation begins when a victim cache line is needed for the L1 cache (block 950). The cache identifies a least recently used (LRU) cache line in the L1 cache (block 951). The cache removes (invalidates) the entry in the L1 directory (block 952), and operation ends (block 953).

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for combining the directories for a local cache and a higher level cache to save area on the processor chip and to reduce latency. The local cache is a subset of the higher level cache. The local cache directory and the higher level cache directory are accessed in parallel during the execution of storage instructions and cross invalidations to determine cache hits. The local cache does not contain absolute address tags, but instead contains logical pointers to the higher level cache directory. The mechanisms modify least recently used targets in the local cache to maintain the subset rule. The mechanisms efficiently determine a cache hit in the local cache by using the results of the absolute address compares of the higher level cache.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Moderns, cable moderns and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for accessing a cache, the method comprising:
responsive to receiving a logical address for a cache access, looking up a first portion of the logical address in a local cache directory for a local cache, wherein the local cache directory returns a logical pointer to a higher level cache directory, wherein the logical pointer comprises a set identifier for each matching set in the local cache directory, wherein the set identifier indicates a set within a higher level cache directory;
looking up the logical address in a translation look-aside buffer, wherein the translation look-aside buffer returns an absolute address;
looking up a third portion of the logical address in the higher level cache directory in parallel with looking up the first portion of the logical address in the local cache directory, wherein the higher level cache directory returns an absolute address value for each set in the higher level cache directory;
comparing each absolute address value received from the higher level cache directory to the absolute address received from the translation look-aside buffer to generate a higher level cache hit signal;
generating a local cache hit signal based on results of comparing each absolute address value received from the higher level cache directory to the absolute address received from the translation look-aside buffer; and
responsive to the local cache hit signal indicating a local cache hit, confirming access of a set of the local cache based on the local cache hit signal.

2. The method of claim 1, wherein each entry in the higher level cache directory stores an absolute address value, a valid bit, an exclusivity bit, and a storage key.

3. The method of claim 2, wherein a given entry in the local cache directory stores a valid bit, a third portion of the logical address, and the set identifier, wherein the logical pointer comprises the set identifier and the third portion of the logical address.

4. The method of claim 3, wherein confirming the access of the set of the local cache comprises:
combining the first portion of the logical address and the third portion of the logical address to form an access address; and
confirming the access of the set of the local cache identified by the local cache hit signal using the access address.

5. The method of claim 4, further comprising:
responsive to the local cache hit signal indicating a local cache hit, accessing a set of the higher level cache directory identified by the local cache hit signal using the access address to obtain an exclusivity bit and a storage key.

6. The method of claim 1, further comprising:
responsive to the local cache hit signal indicating a local cache miss and the higher level cache hit signal indicating a higher level cache hit, confirming access of a set of the higher level cache based on the higher level cache hit signal.

7. The method of claim 1, further comprising:
responsive to identifying a least recently used target for replacement in the higher level cache directory, determining whether an entry in the local cache directory references the least recently used target in the higher level cache directory; and
responsive to determining a given entry in the local cache directory references the least recently used target in the higher level cache directory, marking the given entry in the local cache director as a target for replacement.

8. An apparatus for accessing a cache, comprising:
a local cache directory configured to receive a first portion of a logical address in a local cache directory for a local cache and return a logical pointer to a higher level cache directory, wherein the logical pointer comprises a set identifier for each matching set in the local cache directory, wherein the set identifier indicates a set within a higher level cache directory;
a translation look-aside buffer configured to receive the logical address and return an absolute address;
a higher level cache directory configured to receive a second portion of the logical address and return an absolute address value for each set in the higher level cache directory, wherein the higher level cache directory looks up the second portion of the logical address in parallel with the local cache directory looking up the first portion of the logical address;
a first comparison component configured to compare each absolute address value received from the higher level cache directory to the absolute address received from the translation look-aside buffer to generate a higher level cache hit signal; and
a second comparison component configured to compare the higher level cache hit signal to each set identifier to generate a local cache hit signal, wherein responsive to the local cache hit signal indicating a local cache hit, the local cache confirms access of a set of the local cache based on the local cache hit signal.

9. The apparatus of claim 8, wherein each entry in the higher level cache directory stores an absolute address value, a valid bit, an exclusivity bit, and a storage key.

10. The apparatus of claim 9, wherein a given entry in the local cache directory stores a valid bit, a third portion of the logical address, and the set identifier, wherein the logical pointer comprises the set identifier and the third portion of the logical address.

11. The apparatus of claim 10, wherein confirming the access of the set of the local cache comprises:
combining the first portion of the logical address and the third portion of the logical address to form an access address; and
confirming the access of the set of the local cache identified by the local cache hit signal using the access address.

12. The apparatus of claim 11, wherein accessing the local cache further comprises:
responsive to the local cache hit signal indicating a local cache hit, accessing a set of the higher level cache directory identified by the local cache hit signal using the access address to obtain an exclusivity bit and a storage key.

13. The apparatus of claim 8, wherein responsive to the local cache hit signal indicating a local cache miss and the higher level cache hit signal indicating a higher level cache hit, the higher level cache confirms access of a set of the higher level cache based on the higher level cache hit signal.

14. A computer program product comprising a computer readable storage medium having a computer readable program stored therein, wherein the computer readable program, when executed on a computing device, causes the computing device to:
responsive to receiving a logical address for a cache access, look up a first portion of the logical address in a local cache directory for a local cache, wherein the local cache directory returns a logical pointer to a higher level cache directory, wherein the logical pointer comprises a set identifier for each matching set in the local cache directory, wherein the set identifier indicates a set within a higher level cache directory;
look up the logical address in a translation look-aside buffer, wherein the translation look-aside buffer returns an absolute address;
look up a second portion of the logical address in the higher level cache directory in parallel with looking up the first portion of the logical address in the local cache directory, wherein the higher level cache directory returns an absolute address value for each set in the higher level cache directory;
compare each absolute address value received from the higher level cache directory to the absolute address received from the translation look-aside buffer to generate a higher level cache hit signal;
generate a local cache hit signal based on results of comparing each absolute address value received from the higher level cache directory to the absolute address received from the translation look-aside buffer; and
responsive to the local cache hit signal indicating a local cache hit, confirm access of a set of the local cache based on the local cache hit signal.

15. The computer program product of claim 14, wherein each entry in the higher level cache directory stores an absolute address value, a valid bit, an exclusivity bit, and a storage key, and wherein a given entry in the local cache directory stores a valid bit, a third portion of the logical address, and the set identifier, wherein the logical pointer comprises the set identifier and the third portion of the logical address.

16. The computer program product of claim 15, wherein confirming the access of the set of the local cache comprises:
combining the first portion of the logical address and the third portion of the logical address to form an access address; and
confirming the access of the set of the local cache identified by the local cache hit signal using the access address.

17. The computer program product of claim 16, wherein the computer readable program further causes the computing device to:
responsive to the local cache hit signal indicating a local cache hit, access a set of the higher level cache directory identified by the local cache hit signal using the access address to obtain an exclusivity bit and a storage key.

18. The computer program product of claim 14, wherein the computer readable program further causes the computing device to:
responsive to the local cache hit signal indicating a local cache miss and the higher level cache hit signal indicating a higher level cache hit, confirm access of a set of the higher level cache based on the higher level cache hit signal.

19. The computer program product of claim 14, wherein the computer readable program is stored in a computer readable storage medium in a data processing system and wherein the computer readable program was downloaded over a network from a remote data processing system.

20. The computer program product of claim 14, wherein the computer readable program is stored in a computer readable storage medium in a server data processing system and wherein the computer readable program is downloaded over a network to a remote data processing system for use in a computer readable storage medium with the remote system.
